(19) United States
(12) Patent Application Publication
(10) Pub. No.: US 2006/0005910 A1
(43) Pub. Date: Jan. 12, 2006

(54) Template for laying tile

(76) Inventor: Princess L. Jones, Jacksonville, FL (US)

Correspondence Address: PRINCESS L. JONES, 2647 LANTANA LAKES COURT, JACKSONVILLE, FL, 32246, US

(21) Appl. No.: 10/887,407

(22) Filed: Jul. 9, 2004

(51) Int. Cl. E04B 2/00; G01B 1/00; E04F 13/00

(52) U.S. Cl. 156/71; 33/526

(57) ABSTRACT

The present invention is a template for laying tile for the purpose of even spacing and accurate placement of patterns while laying tile. The invention is constructed of fiberglass screening, but can also be made of any light weight, breathable materials or fabrics that will keep its shape and/or form, such as plastics, etc. The preferred fiberglass screening has permanently attached spacers that provide the template pattern by which the tiles are laid. The fiberglass screening is ventilated and porous enough that when placed on a surface the tile cement can still penetrate through to the floor surface to assure good adhesion. Attached to the underside edges of the fiberglass screening is an adhesive which allows the mesh to be secured to the floor. The edges are constructed of a firm material in order to hold the screening in position and allow sufficient surface so that the adhesive may stick. The invention is manufactured in a variety of sizes based on desired specifications. The spacers vary in size depending on the desired width of the grout seam required. The spacers are cross shaped and are made of rubber, plastic or a like material, and are permanently attached to the fiberglass screening and are pre-set at the dimensions and size of the tiles for easy and accurate placement and spacing. The spacers are purposely low enough so they can be grouted over. The tile template can be designed to accommodate any tile size and dimension (4×4, 12×12, 6×12, etc) and can be used with all types of tiles such as marbles, ceramic, slate or bricks. The invention can be used on floors and walls. The present invention has a preferred list of parts and a sequence of use.

### BACKGROUND OF THE INVENTION

(1) Field of the Invention

The present invention generally relates to a template and, more particularly pertains to a template for correctly aligning ceramic floor tile.

(2) Description of the Prior Art

The present invention is an improvement over U.S. Pat. No. 6,729,035 B1 which discloses a flexible, clear-ruled tile template having the same dimensions as the piece of tile being laid. U.S. Pat. No. 5,922,157 is an apparatus and method for installing tile or other rigid floor or wall coverings around obstacles in irregularly shaped areas. U.S. Pat. No. 5,201,130 is a tile template comprising first and second opposed arms disposed at right angles to the first and second opposed arms.

### SUMMARY OF THE INVENTION

In view of the forgoing disadvantages inherent in the known tile templates now present in the prior art, the present invention provides a new and improved template means for placing tile with grout placed there around. As such, the general purpose of the present invention, which will be described subsequently in greater detail, is to provide a new and improved template for laying tile apparatus and method of use which has all the advantages of the prior art and none of the disadvantages.

To attain this, the present invention provides the improvement of a template for laying tile consisting of a sheet of light weight fiberglass breathable mesh material with even spaced, and permanently attached, spacers positioned at equal distant point on the top surface of the mesh material. This yields accurate placement of patterns while laying tile. The spacers are shaped like a cross with four equal length arms and can be made of rubber, plastic or a like material. The spacers are available in a variety of sizes; widths; depending on the desired width of the grout seam. The underside of the mesh has a two sided adhesive means attached around the peripheral edge so as to hold the mesh in place while placing and cementing the tile in place. The present invention is used for ceramic, porcelain, marble and slate tile, or the like. The present template for laying tile can not be used for floor, peel and stick, tile. The spacers are shorter in height than the finished tile surface so that when the grout is placed into the seams it covers the entire spacer. The complete invention is left in place and completely covered by the tile and the grout placed in the seams. The spacing of the present invention has pre-established measurements so as to match the measurements of the selected tile. In other words the tile does not have to cut to fit the tile template measurements. Both match without any alterations. The present invention can also be used for laying brick, but without the use of spacers, and walls. The tile template can be designed to accommodate any tile size with dimensions such as 4×4, 12×12, 6×12 or similar size.

Optionally, the template of the present invention may be used for laying brick wherein a solid, non-mesh, material, namely landscape matting. This option does not use spacers but rather has alignment lines pre-printed directly on the matting.

The present invention has (1) a preferred list of component parts and (2) a preferred sequence of use.

Preferred List of Component Parts

(1) Fiberglass screening means.
(2) Spacers means
(3) Two-sided adhesive means.
   Method of Use Sequence
(1) Select the correct size tile with spacer template to match your tile placement job.
(2) Remove the template for laying tile from its package.
(3) Remove the backing from the adhesive on the underside of the mesh apparatus.
(4) Place the complete template for laying tile mesh apparatus onto the desired area to be tiled and secure in place to the floor, or wall, by pressing down on the adhesive.
(5) Place the desired tile cement in place.
(6) Place the tile and press the tile section securely in position according to the mesh template layout.
(7) Place and secure the balance of the tiles in place.
(8) Pour the grout into the seams and let harden to specifications.

There has thus been outlined, rather broadly, the of the invention in order that the detailed description thereof that follows may be better understood, and in order that the present contribution to the art may be better appreciated. There are, of course, additional features of the present invention that will be described hereinafter and which will form the subject matter of the claims appended hereto.

In this respect, before explaining at least one embodiment of the present invention in detail, it is to be understood that the present invention is not limited in its application to the details of construction and the arrangement of the components set forth in the following description or illustrated in the drawings. The invention is capable of other embodiments and of being practiced and carried out in various ways, also, it is to be fully understood that the phraseology and terminology employed herein are for the purpose of description and should not be regarded as limited.

As such, those skilled in the art will appreciate that the conception, upon which this disclosure is based, may readily be utilized as a basis for the designing of other structures, methods and systems for carrying out the several purpose of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the present application. The abstract is neither intended to define the invention of the application, which is measured by the claims, nor is it intended to be limited as to the scope of the present invention in any way.

It is therefore an object of the present invention to provide a new and improved template for laying tile which has the advantage of the prior art devises and none of the disadvantages.

It is another object of the present invention to provide a new and improved template for laying tile which may be easily and efficiently manufactured and marketed.

It is a further object of the present invention to provide a new and improved tile template which is of a durable and reliable construction.

An even further object of the present invention is to provide a new and improved template for laying tile which is susceptible of a low cost of manufacture with regard to both materials and labor, and which accordingly is then susceptible of low prices of sale to the consuming public, thereby making such template for laying tile economically available to the buying public.

Still yet another object of the present invention is to provide a new and improved template for laying tile which provides in the apparatuses and methods of the prior art some of the advantages thereof, while simultaneously overcoming some of the advantages normally associated therewith.

Still another object of the present invention is to provide a new and improved template for laying tile operable from a novice's level.

Yet another object of the present invention is to provide a new and improved template for laying tile system.

These together with other objects of the present invention, along with the various features of novelty which characterize the present invention, are pointed out with a particularity in the claims annexed to and forming a part of this disclosure. For a better understanding of the present invention, its operating and installation advantages and the specific objects attained by its uses, reference should be had to the accompanying drawings and descriptive matter in which there are illustrated preferred embodiments of the present invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a flat top view of the invention.

FIG. 2 is a flat bottom view of the invention.

FIG. 3 is an enlarged perspective view showing one tile in the correct position between four spacers on the mesh.

FIG. 4 (A) is a flat top view of a spacer and (B) is a perspective view of a spacer for the present invention.

FIG. 5 is a side view of two tiles on the mesh with a spacer and NO grout.

FIG. 6 is a side view of the same two tiles on the mesh with a spacer and grout in place.

### DESCRIPTION OF THE PREFERRED EMBODIMENT

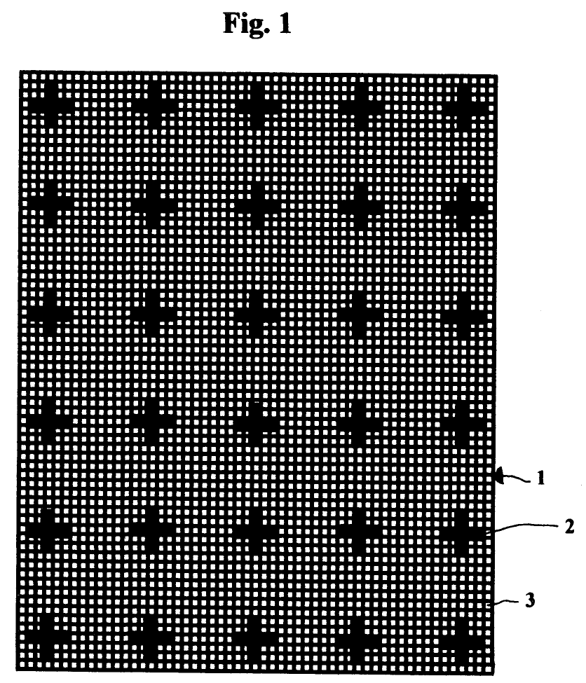

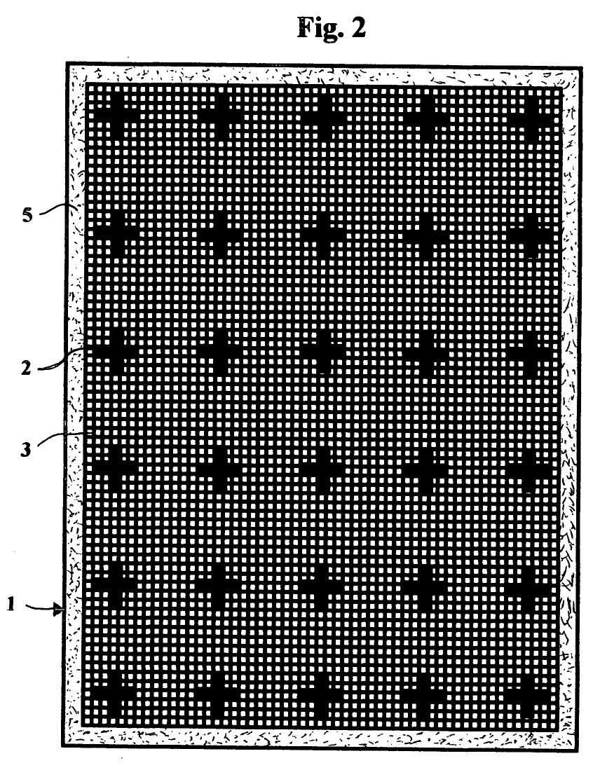

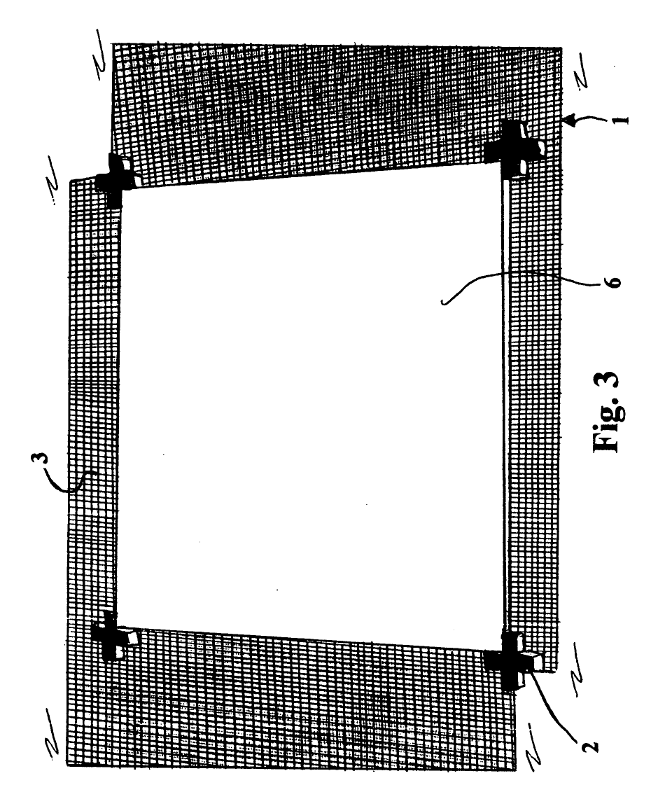

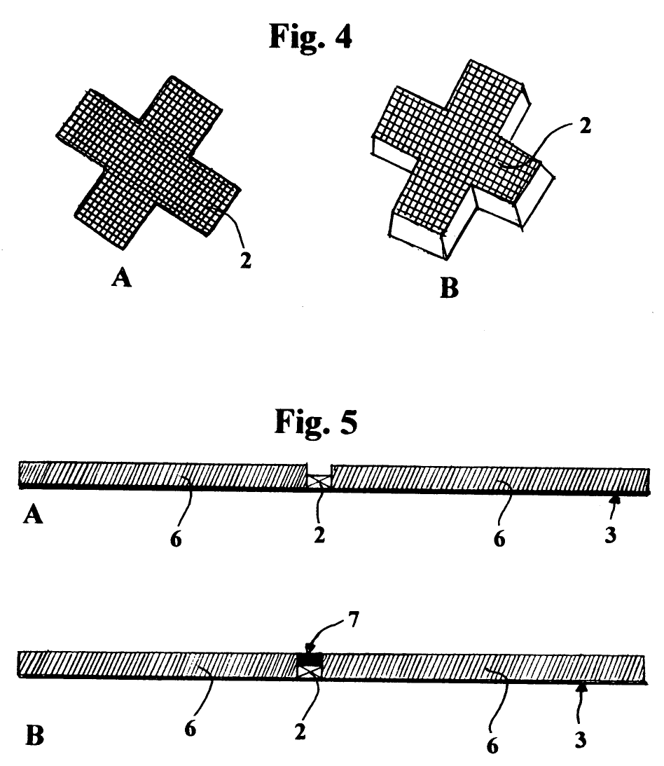

FIG. 1 is a top flat view showing tile template 1 with spacers 2 fiberglass mesh 3. FIG. 2 is a flat bottom view of tile template 1 with spacers 2 fiberglass mesh 3 and adhesive 5 placed around the peripheral edge. FIG. 3 is an enlarged view of tile template 1 with one tile 6 correctly positioned between four spacers 2 on fiberglass mesh 3. FIG. 4 (A) is a flat view of one spacer 2 while (B) is a perspective view showing spacer 2. FIG. 5 (A) is a side view of two tiles 6 with spacer 2 there between on mesh 3 while (B) is also a side view of two tiles 6 with spacer 2 and grout 7 on mesh 3.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will be readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by letters patent of the United States is as follows:

1. A template for laying tile comprising, in combination;
a mesh means; said mesh having a top and bottom surface means;
a spacer means;
an alignment means;
an adhesive means;
a floor means; and
said template for laying tile has a preferred list of component parts and a method of use sequence.

2. The invention as claimed in claim 1 wherein said mesh means consists of a sheet of light weight fiberglass breathable porous mesh material such as screening for doors said mesh accepts and retains equal distance placed apart spacers which are permanently attached to the top surface of said mesh thereby said mesh means provides the perfect template for the placement of any tile.

3. The invention as claimed in claim 1 wherein said mesh means with said component parts can be manufactured so as to accommodate any dimension tile such as 4×4, 12×12, 6×12 or any similar size.

4. The invention as claimed in claim 1 wherein said spacers are permanently attached to the top surface of said mesh said spacers are shaped like a cross with four equal length arms said spacers are made of rubber, plastic or like material said spacers are available in a variety of sizes and widths depending on the desired width of said grout seam said spacers are shorter in height than the finished tile surface so that when the grout is placed into the grout seams said grout covers said entire spacer.

5. The invention as claimed in claim 1 wherein said mesh means has a top side and a bottom side said top side acts as the visual template and said bottom side has a two sided adhesive attached so as to stabilize said mesh means to said floor means while placing said tile said adhesive attaches said mesh to said floor means said adhesive means is positioned around the peripheral edge of said mesh means while said adhesive holds said mesh in place while placing and cementing said tile in place.

6. The invention as claimed in claim 1 wherein said tile can be selected from a wide selection such as ceramic, porcelain, marble, slate of the like.

7. The invention as claimed in claim 1 wherein said complete template for laying tile invention is left in place and completely covered by said tile and said grout placed in said seams.

8. The invention as claimed in claim 1 wherein said template means can be used optionally for laying brick and on walls while said template may be used for laying said brick wherein a solid, non-mesh, material, namely landscape matting is used whereas this option does not use spacers but rather has alignment lines pre-printed directly on the matting.

9. The invention as claimed in claim 1 wherein said template for laying tile is pre-constructed with pre-determined measurements so as to match the measurements of the selected tile.

10. The invention as claimed in claim 1 wherein said preferred list of component parts are;
(1) Fiberglass mesh means with pre-printed alignment lines means thereon said mesh;
(2) Spacer means;
(3) Two-sided adhesive means.

11. The invention as claimed in claim 1 wherein said method of use sequence is;
(a) Select said correct size tile with said spacer template to match your tilt placement job;
(b) Remove said template for laying tile from its package;
(c) Remove the backing from said adhesive on the underside of said mesh means;
(d) Place said complete template means for laying tile onto the desired area to be tiled and secure in place to said floor by pressing down on said adhesive;
(e) Place the desired tile cement in place;
(f) Place said tile and press said tile section securely in position according to said mesh means template layout;
(g) Place and secure the balance of said tiles in place and let dry for 24 hours; and
h) Pour the grout into the seams and let harden to specifications thereby creating a perfect tile placement job by using said present template for laying tile invention.
